(19) United States
(12) Patent Application Publication
(10) Pub. No.: US 2012/0287341 A1
(43) Pub. Date: Nov. 15, 2012

(54) SYSTEM AND METHOD FOR SYNCHRONIZING A VIDEO SIGNAL AND A SENSOR SIGNAL

(75) Inventor: Song Hwan Choi, Daejeon (KR)

(73) Assignee: RD-TEK CO., LTD., Daejeon (KR)

(21) Appl. No.: 13/513,581

(22) PCT Filed: Dec. 3, 2010
(86) PCT No.: PCT/KR2010/008622

§ 371 Date: Jun. 3, 2012

(30) Foreign Application Priority Data
Dec. 4, 2009 (KR) 10-2009-0120102

(51) Int. Cl. H04N 5/04

(52) U.S. Cl. 348/500; 348/E05.104

(57) ABSTRACT

A system synchronizing video and sensor signals includes: a camera acquiring a video signal; a sensor having first synchronization clock, generating a sensor signal corresponding to the video signal, adding, to the sensor signal, acquisition time from the first synchronization clock; a controller having second synchronization clock, controlling to receive the sensor signal with the acquisition time and transmit it to a computer, obtaining cumulative number of acquisition for video signals from the camera, adding the acquisition time from the second synchronization clock to number of acquisition and transmitting the number for analysis for verifying the synchronization; a synchronizer having reference clock and transmitting reference time for synchronization of first and second synchronization clocks to the sensor and the controller; and the computer receiving the sensor signal including acquisition time from the controller and the video signal to check time information and reconstructing the signals in the same time zone.

### TECHNICAL FIELD

The present invention relates to a system and method for synchronizing a video signal and a sensor signal when analyzing multi-channel video signals and sensor signals in a wired or wireless environment, and more specifically, a synchronization clock is embedded in each sensor module and a central control apparatus to synchronize the video signal inputted from a camera and the sensor signal corresponding to each video signal. A synchronization apparatus transmits a synchronization signal to each apparatus to synchronize the synchronization clocks, and the sensor apparatus adds an acquisition time to the acquired sensor signal and transmits the sensor signal to a computer apparatus via the central control apparatus. The central control apparatus adds an acquisition time to the number of acquisitions of the video signal transmitted from the camera to the computer apparatus and transmits the number of acquisitions to the computer apparatus, and the computer apparatus performs synchronization for the video signal and the sensor signal.

### BACKGROUND ART

Recently, a camera for photographing a subject and acquiring a video signal is adopted and used in a cellular phone or a notebook computer carried by a user. In addition, apparatuses for utilizing the video signal acquired through the camera in a gaming device or the like such as an archery analyzer are introduced.

The gaming device or the like is provided with a sensor for sensing surrounding circumstances, e.g., sensing wind directions or wind speed or sensing tension, a slope, temperature or pressure.

However, when it needs to match the video signal acquired from the camera to a sensor signal sensed through a sensor and provide the signals to a user, synchronization of the two signals is very important to improve quality of service.

However, when the video signal or the sensor signal needs to be transmitted in a high-speed wireless communication on a multi-channel of at least two or more channels, synchronization of individual signals collected according to surrounding environments is very difficult to secure.

### DISCLOSURE OF INVENTION

### Technical Problem

Therefore, the present invention has been made in view of the above problems, and it is an object of the present invention to provide a system and method for synchronizing a video signal and a sensor signal, a synchronization apparatus and a method of synchronizing a video signal and a sensor signal thereof, and a computer apparatus and a method of synchronizing a video signal and a sensor signal thereof, in which a synchronization clock is embedded in each sensor module and a central control apparatus to synchronize the video signal inputted from a camera and the sensor signal corresponding to each video signal. The synchronization apparatus transmits a synchronization signal to each apparatus to synchronize the synchronization clocks, and the sensor apparatus adds an acquisition time to the acquired sensor signal and transmits the sensor signal to a computer apparatus via the central control apparatus. Then, the central control apparatus adds an acquisition time to the number of acquisitions of the video signal transmitted from the camera to the computer apparatus and transmits the number of acquisitions to the computer apparatus, and the computer apparatus performs synchronization for the video signal and the sensor signal.

### Technical Solution

To accomplish the above object, according to one aspect of the present invention, there is provided a system for synchronizing a video signal and a sensor signal, the system including: a camera apparatus for acquiring the video signal by photographing a subject, and outputting and transmitting the acquired video signal; a sensor apparatus embedded with a first synchronization clock, for generating the sensor signal corresponding to the video signal according to a sensing operation, adding acquisition time information of the first synchronization clock to the generated sensor signal, and outputting the sensor signal; a central control apparatus embedded with a second synchronization clock, for controlling to receive the sensor signal added with the acquisition time information from the sensor apparatus and transmit the sensor signal to the computer apparatus, continuously accumulating the number of acquisitions of the video signal transmitted from the camera apparatus to the computer apparatus, adding acquisition time information of the second synchronization clock to the number of acquisitions, transmitting the number of acquisitions to the computer apparatus or storing the number of acquisitions, and verifying synchronization using the number of acquisitions when performing analysis; a synchronization apparatus embedded with a reference clock, for simultaneously transmitting a reference time for synchronizing the first synchronization clock and the second synchronization clock to the sensor apparatus and the central control apparatus at regular intervals; and a computer apparatus for receiving the sensor signal added with the acquisition time information from the central control apparatus, receiving the video signal from the camera apparatus, confirming the acquisition time information of each of the video signal and the sensor signal, reconfiguring each of the signals in the same time zone, and synchronizing the video signal and the sensor signal.

In addition, the sensor apparatus synchronizes the first synchronization clock based on the reference time received from the synchronization apparatus, adds acquisition time information of the first synchronization clock to the sensor signal generated according to a sensing operation, and transmits the sensor signal to the central control apparatus.

In addition, the sensor apparatus compares the reference time received from the synchronization apparatus with a time of the second synchronization clock and performs correction as much as a time difference, adds acquisition time information to the sensor signal based on the corrected time, and transmits the sensor signal to the central control apparatus.

In addition, the sensor apparatus obtains a time difference by comparing the reference time received from the synchronization apparatus with the time of the first synchronization clock and transmits the obtained time difference to the computer apparatus, and the computer apparatus corrects the sensor signal received from the sensor apparatus as much as the time difference on a time axis.

In addition, the synchronization apparatus requests and acquires current time information from the sensor apparatus, confirms a time difference range by comparing the acquired current time information with the reference time information, and transmits correction time information and a time correction command to the sensor apparatus if correction is needed.

Then, if the time correction command is received, the sensor apparatus performs correction based on the received correction time information, performs synchronization using a clock received from the synchronization apparatus at a second clock, and transmits a correction completion command to the synchronization apparatus.

According to another aspect of the present invention, there is provided a synchronization apparatus including: a communication unit for communicating with a sensor apparatus, a central control apparatus and a computer apparatus; a frequency generation unit for generating a frequency signal in order to transmit reference time information for synchronization to the sensor apparatus, the central control apparatus and the computer apparatus; a synchronization clock unit for generating a clock signal from the generated frequency signal; a reference time module unit (FPGA) for generating the reference time information from the generated clock signal; a real-time clock (RTC) unit for providing the reference time module unit with a real time clock; and a control unit for controlling the frequency generation unit, the synchronization clock unit and the reference time module unit to generate the reference time information and transmit the generated reference time information to the sensor apparatus, the central control apparatus and the computer apparatus.

In addition, the control unit requests and acquires current time information from the sensor apparatus, confirms a time difference range by comparing the acquired current time information with the reference time information, and transmits correction time information and a time correction command to the sensor apparatus if correction is needed.

Then, the synchronization apparatus further includes: an A/D converter for converting an analog signal inputted from the sensor apparatus, the central control apparatus and the computer apparatus into a digital signal; an output unit for outputting the digital signal; and a display unit for displaying an operation of generating the reference time information, the current time information, and an operation of transmitting the time correction command.

According to still another aspect of the present invention, there is provided a sensor apparatus including: a sensor for generating a sensor signal sensing a slope, tension, weight or the like; a signal conversion unit for converting the sensor signal of an analog form into sensor data of a digital form; a communication unit for transmitting the sensor data to a synchronization apparatus and a central control apparatus; a synchronization clock unit for performing synchronization using a reference time provided by the synchronization apparatus; a memory unit for storing the sensor data; a control unit for controlling to transmit the sensor data to the central control apparatus, receive the reference time from the synchronization apparatus and synchronize using the reference time, and transmit acquisition time information of the sensor data to the central control apparatus with the sensor data; a frequency generation unit for generating a frequency signal and providing the control unit with the frequency signal; and a real-time clock module (RTC) unit for providing the control unit with a real time clock.

According to still another aspect of the present invention, there is provided a method of synchronizing a video signal and a sensor signal of a system including a camera apparatus, a sensor apparatus, a central control apparatus, a synchronization apparatus and a computer apparatus, the method including the steps of: (a) transmitting synchronization time information to the sensor apparatus and the central control apparatus by the synchronization apparatus; (b) synchronizing an embedded synchronization clock based on the synchronization time information by the sensor apparatus and the central control apparatus, respectively; (c) acquiring and transmitting the video signal to the computer apparatus by the camera apparatus; (d) acquiring the sensor signal, adding acquisition time information of the embedded synchronization clock to the sensor signal, and transmitting the sensor signal to the central control apparatus by the sensor apparatus, and transmitting the sensor signal added with the acquisition time information to the computer apparatus by the central control apparatus; and (e) performing synchronization of the video signal and the sensor signal based on time information of the embedded synchronization clock and the acquisition time information by the computer apparatus.

Then, in step (e), the computer apparatus calculates a time difference by comparing the time information of the embedded synchronization clock and the acquisition time information and synchronizes the video signal and the sensor signal by correcting the video signal and the sensor signal as much as the time difference on the time axis.

According to still another aspect of the present invention, there is provided a method of synchronizing a video signal and a sensor signal of a synchronization apparatus communicating with a specific apparatus including a sensor apparatus, a central control apparatus and a computer apparatus in a wired or wireless communication, the method including the steps of: (a) requesting and receiving current time information from the specific apparatus; (b) acquiring time difference information by comparing the current time information with reference time information; (c) generating time information for correcting the time difference information, and transmitting the time information and a time correction command to the specific apparatus; and (d) receiving a synchronization completion command informing completion of synchronization as a time correction performed based on the time information from the specific apparatus.

According to still another aspect of the present invention, there is provided a method of synchronizing a video signal and a sensor signal of a computer apparatus communicating with a camera apparatus, a sensor apparatus, a central control apparatus and a synchronization apparatus in a wired or wireless communication, the method including the steps of: (a) receiving reference time information from the synchronization apparatus and synchronizing an embedded synchronization clock; (b) receiving the video signal from the camera apparatus, and receiving the sensor signal acquired by the sensor apparatus and added with acquisition time information from the central control apparatus; and (c) synchronizing the video signal and the sensor signal based on time information of the embedded synchronization clock and the acquisition time information.

In addition, step (c) calculates a time difference by comparing the time information of the embedded synchronization clock and the acquisition time information and synchronizes the video signal and the sensor signal by correcting the video signal and the sensor signal as much as the time difference on a time axis.

Then, step (c) synchronizes the video signal and the sensor signal by correcting the video signal and the sensor signal as much as time difference information on the time axis based on the time difference information received from the sensor apparatus and the central control apparatus.

### Advantageous Effects

According to the present invention, synchronization of video signals and sensor signals collected depending on surrounding environments can be secured.

In addition, users can be provided with improved services through synchronization of multi-channel high-speed video signals and sensor signals corresponding thereto.

Furthermore, synchronization of the two signals can be easily implemented regardless of a communication means which acquires video signals and sensor signals and transmits the signals in a wired or wireless communication, and accordingly, the video signals and the sensor signals can be correctly and conveniently analyzed.

### BRIEF DESCRIPTION OF THE DRAWINGS

FIG. 1 is a view schematically showing the configuration of a system for synchronizing a video signal and a sensor signal according to an embodiment of the present invention.

FIG. 2 is a view schematically showing the internal configuration of a synchronization apparatus according to an embodiment of the present invention.

FIG. 3 is a view schematically showing the internal configuration of a sensor apparatus according to an embodiment of the present invention.

FIG. 4 is an overall flowchart illustrating a method of synchronizing a video signal and a sensor signal according to an embodiment of the present invention.

FIG. 5 is a flowchart illustrating a method of synchronizing a video signal and a sensor signal of a synchronization apparatus according to an embodiment of the present invention.

FIG. 6 is a view showing a synchronization procedure and a timing diagram according to an embodiment of the present invention.

FIG. 7 is a flowchart illustrating a method of synchronizing a video signal and a sensor signal of a computer apparatus according to an embodiment of the present invention.

### BEST MODE FOR CARRYING OUT THE INVENTION

The preferred embodiments of the present invention will be hereafter described in detail, with reference to the accompanying drawings. Furthermore, in the drawings illustrating the embodiments of the present invention, elements having like functions will be denoted by like reference numerals and details thereon will not be repeated.

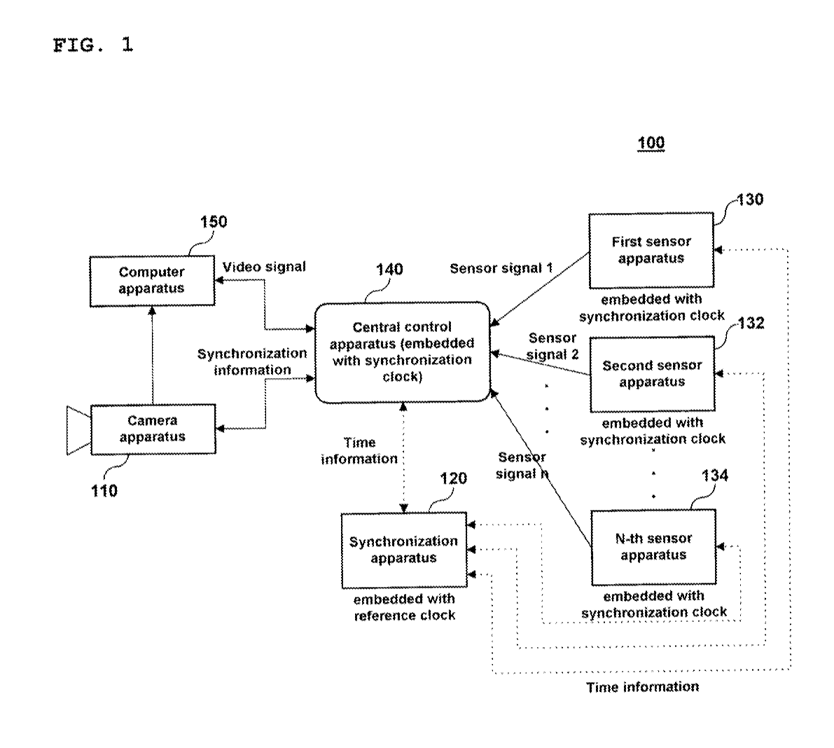

FIG. 1 is a view schematically showing the configuration of a system for synchronizing a video signal and a sensor signal according to an embodiment of the present invention.

Referring to FIG. 1, the system for synchronizing a video signal and a sensor signal 100 according to the present invention includes a camera apparatus 110, a synchronization apparatus 120, a plurality of sensor apparatuses 130 to 134, a central control apparatus 140 and a computer apparatus 150.

The camera apparatus 110 acquires a video signal by photographing a subject and outputs and transmits the acquired video signal to the computer apparatus 150.

The synchronization apparatus 120 is embedded with a reference clock and simultaneously transmits a reference time for synchronizing the sensor apparatuses 130 to 134 and the central control apparatus 140 to the sensor apparatuses 130 to 134 and the central control apparatus 140 at regular intervals.

The plurality of sensor apparatuses 130 to 134 is embedded with a first synchronization clock, generates a sensor signal corresponding to the video signal according to a sensing operation, adds acquisition time information of the first synchronization clock to the generated sensor signal, and outputs and transmits the sensor signal to the central control apparatus 140.

Here, the plurality of sensor apparatuses 130 to 134, for example, may be an archery analyzer for sensing a slope of an arrow or tension, a foot motion analyzer (X-balance) for sensing foot motions of a user in forward, backward, left and right directions, or a climate analyzer for sensing wind directions or wind speed in the surroundings. At this point, tension, a slope or like can be a sensor signal in the case of the archery analyzer, front, rear, left or right can be a sensor signal in the case of the foot motion analyzer, and wind directions or wind speed can be a sensor signal in the case of the climate analyzer. Other than these, temperature, pressure or the like can be a sensor signal depending on sensing characteristics of a sensor.

The central control apparatus 140 is embedded with a second synchronization clock and controls to receive the sensor signal added with the acquisition time information from the sensor apparatuses 130 to 134 and transmit the sensor signal to the computer apparatus 150.

In addition, the central control apparatus 140 continuously accumulates the number of acquisitions of the video signal transmitted from the camera apparatus 110 to the computer apparatus 150, stores the number of acquisitions together with time information of the second synchronization clock, and verifies synchronization using the number of acquisitions when performing analysis.

The computer apparatus 150 receives the sensor signal added with the acquisition time information from the central control apparatus 140, receives the video signal from the camera apparatus 110, confirms the acquisition time information of each of the video signal and the sensor signal, reconfigures each of the signals in the same time zone, and synchronizes the video signal and the sensor signal. Here, the computer apparatus may be a desktop PC or a portable notebook PC.

In addition, the sensor apparatuses 130 to 134 synchronize the first synchronization clock based on the reference time received from the synchronization apparatus 120, add acquisition time information of the first synchronization clock to the sensor signal generated according to a sensing operation, and transmit the sensor signal to the central control apparatus 140.

In addition, the sensor apparatuses 130 to 134 compare the reference time received from the synchronization apparatus 120 with the time of the first synchronization clock and perform correction as much as a time difference, add acquisition time information to the sensor signal based on the corrected time, and transmit the sensor signal to the central control apparatus 140.

In addition, the sensor apparatuses 130 to 134 obtain a time difference by comparing the reference time received from the synchronization apparatus 120 with the time of the first synchronization clock and transmit the obtained time difference to the computer apparatus 150, and the computer apparatus 150 corrects the sensor signal received from the sensor apparatuses 130 to 134 as much as the time difference on the time axis.

In addition, the synchronization apparatus 120 requests and acquires current time information from the sensor apparatuses 130 to 134, confirms a time difference range by comparing the acquired current time information with reference time information, and transmits correction time information and a time correction command to the sensor apparatuses 130 to 134 if correction is needed.

In addition, if the time correction command is received, the sensor apparatuses 130 to 134 perform correction based on the received correction time information, perform synchronization using a clock received from the synchronization apparatus 120 at the second clock, and transmit a synchronization (correction) completion command to the synchronization apparatus 120.

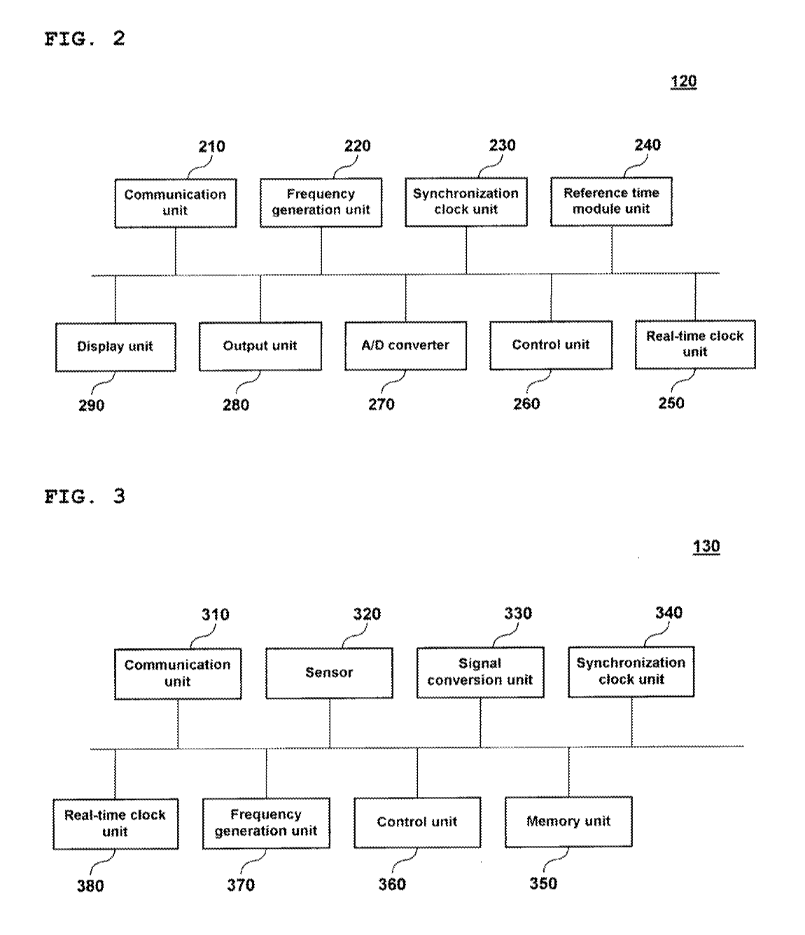

FIG. 2 is a view schematically showing the internal configuration of a synchronization apparatus according to an embodiment of the present invention.

Referring to FIG. 2, the synchronization apparatus 120 according to the present invention includes a communication unit 210, a frequency generation unit (oscillator) 220, a synchronization clock unit 230, a reference time module unit 240, a real-time clock unit 250, a control unit 260, an analog to digital (A/D) converter 270, an output unit 280 and a display unit 290.

The communication unit 210 communicates with the sensor apparatuses 130 to 134, the central control apparatus 140 and the computer apparatus 150.

The frequency generation unit 220 generates a frequency signal in order to transmit reference time information for synchronization to the sensor apparatuses 130 to 134, the central control apparatus 140 and the computer apparatus 150.

The synchronization clock unit 230 generates a clock signal from the frequency signal generated by the frequency generation unit 220.

The reference time module unit 240 generates the reference time information from the generated clock signal.

The real-time clock unit 250 provides the reference time module unit 240 with a real time clock (RTC).

The control unit 260 controls the frequency generation unit 220, the synchronization clock unit 230 and the reference time module unit 240 to generate the reference time information and transmit the generated reference time information to the sensor apparatuses 130 to 134, the central control apparatus 140 and the computer apparatus 150.

In addition, the control unit 260 requests and acquires current time information from the sensor apparatuses 130 to 134, confirms a time difference range by comparing the acquired current time information with the reference time information, and transmits correction time information and a time correction command to the sensor apparatuses 130 to 134 if correction is needed.

The A/D converter 270 converts an analog signal inputted from the sensor apparatuses 130 to 134, the central control apparatus 140 and the computer apparatus 150 into a digital signal.

The output unit 280 outputs the digital signal to outside through a port.

The display unit 290 displays the operation of generating the reference time information, the current time information, and the operation of transmitting the time correction command.

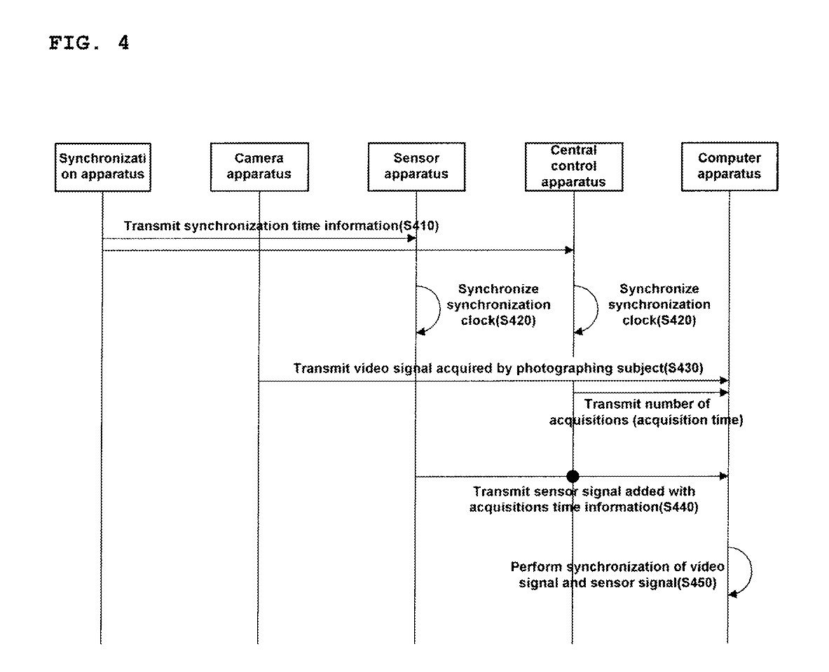

FIG. 3 is a view schematically showing the internal configuration of a sensor apparatus according to an embodiment of the present invention.

Referring to FIG. 3, the sensor apparatus 130 according to the present invention includes a communication unit 310, a sensor 320, a signal conversion unit, 330, a synchronization clock unit 340, a memory unit 350, a control unit 360, a frequency generation unit 370 and a real-time clock unit 380.

The communication unit 310 transmits sensor data to the synchronization apparatus 120 and the central control apparatus 140.

The sensor 320 generates a sensor signal sensing a slope, tension, weight or the like.

The signal conversion unit 330 converts the sensor signal of an analog form into sensor data of a digital form.

The synchronization clock unit 340 performs synchronization using reference time provided by the synchronization apparatus 120.

The memory unit 350 stores the sensor data.

The control unit 360 controls to transmit the sensor data to the central control apparatus 140, receive the reference time from the synchronization apparatus 120, perform synchronization using the reference time, and transmit, acquisition time information of the sensor data to the central control apparatus 140 together with the sensor data.

The frequency generation unit 370 generates a frequency signal and provides the control unit 460 with the frequency signal.

The real-time clock unit 380 provides the control unit 460 with a real time clock (RTC).

FIG. 4 is an overall flowchart illustrating a method of synchronizing a video signal and a sensor signal according to an embodiment of the present invention.

Referring to FIG. 4, first, the synchronization apparatus 120 transmits synchronization time information to the sensor apparatuses 130 to 134 and the central control apparatus 140 S410.

Then, the sensor apparatuses 130 to 134 and the central control apparatus 140 synchronize an embedded synchronization clock based on the synchronization time information, respectively S420.

Next, the camera apparatus 110 transmits a video signal acquired by photographing a subject to the computer apparatus 150.

At this point, the central control apparatus 140 continuously accumulates the number of acquisitions of the video signal transmitted from the camera apparatus 110 to the computer apparatus 150, stores the accumulated number of acquisitions together with time information of the second synchronization clock, and verifies synchronization using the number of acquisitions when performing analysis.

In addition, the sensor apparatuses 130 to 134 acquire a sensor signal through the sensor 320, add acquisition time information to the sensor signal, and transmit the sensor signal to the central control apparatus 140, and the central control apparatus 140 transmits the sensor signal added with the acquisition time information to the computer apparatus S440.

Here, the video signal generally has a big size and thus is directly transmitted to the computer apparatus 150 as is added with the acquisition time information without passing through the central control apparatus 140.

Accordingly, the computer apparatus 150 performs synchronization of the video signal and the sensor signal based on the time information of the second synchronization clock and the acquisition time information S450.

At this point, the computer apparatus 150 corrects time difference of each signal based on the time difference information received from the central control apparatus 140 and the sensor apparatuses 130 to 134 and synchronizes the video signal and the sensor signal.

In addition, the computer apparatus 150 calculates a time difference by comparing the acquisition time information added to the sensor signal with the time information of the second synchronization clock and synchronizes the video signal and the sensor signal by correcting the sensor signal as much as the time difference on the time axis.

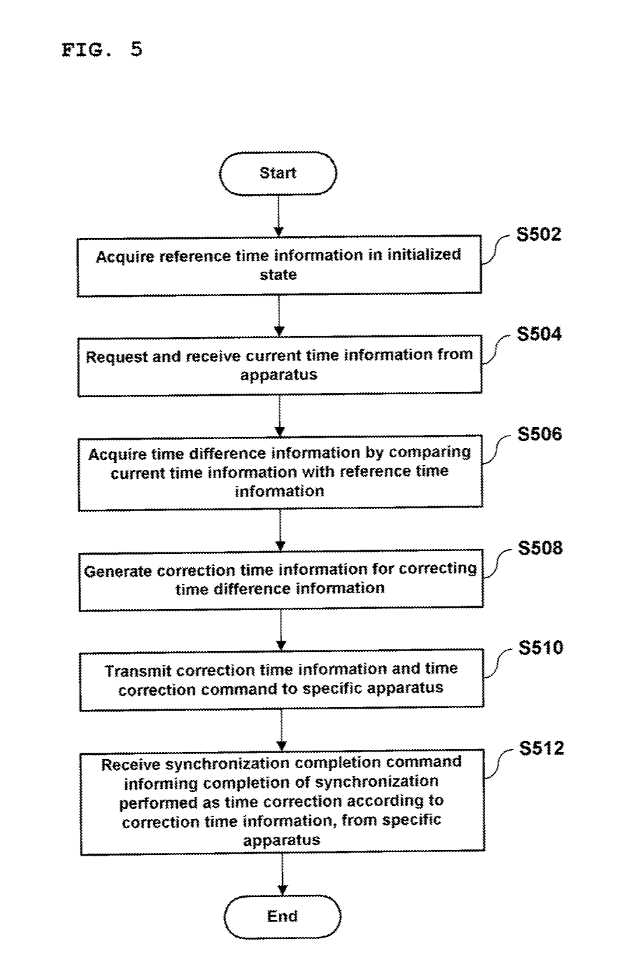

FIG. 5 is a flowchart illustrating a method of synchronizing a video signal and a sensor signal of a synchronization apparatus according to an embodiment of the present invention.

Referring to FIG. 5, the synchronization apparatus 120 according to the present invention acquires reference time information through the reference time module unit 240 while the system is initialized S502.

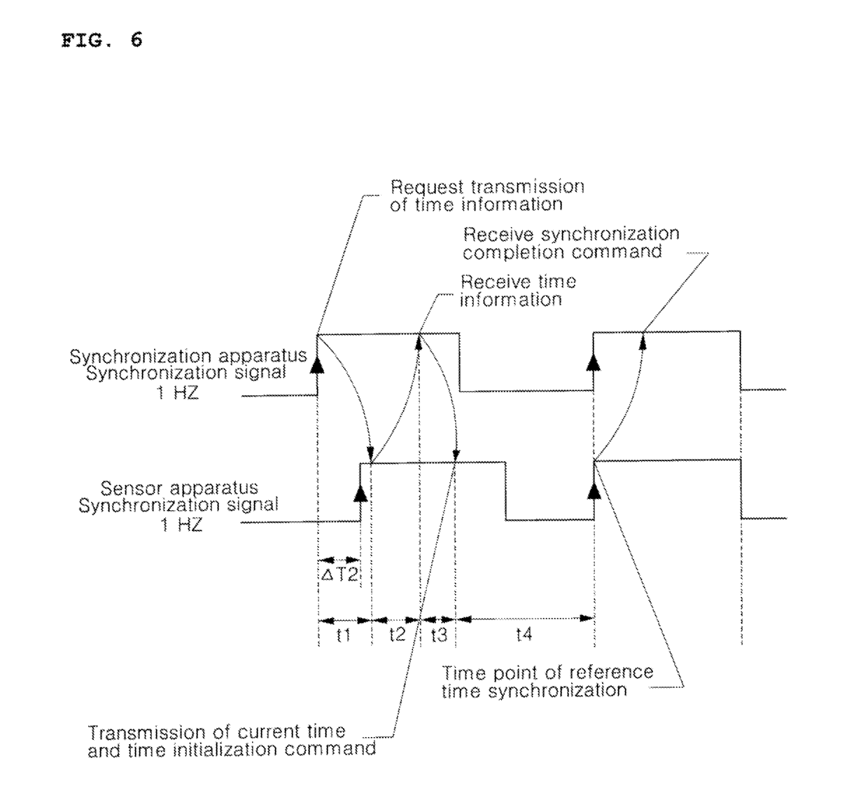

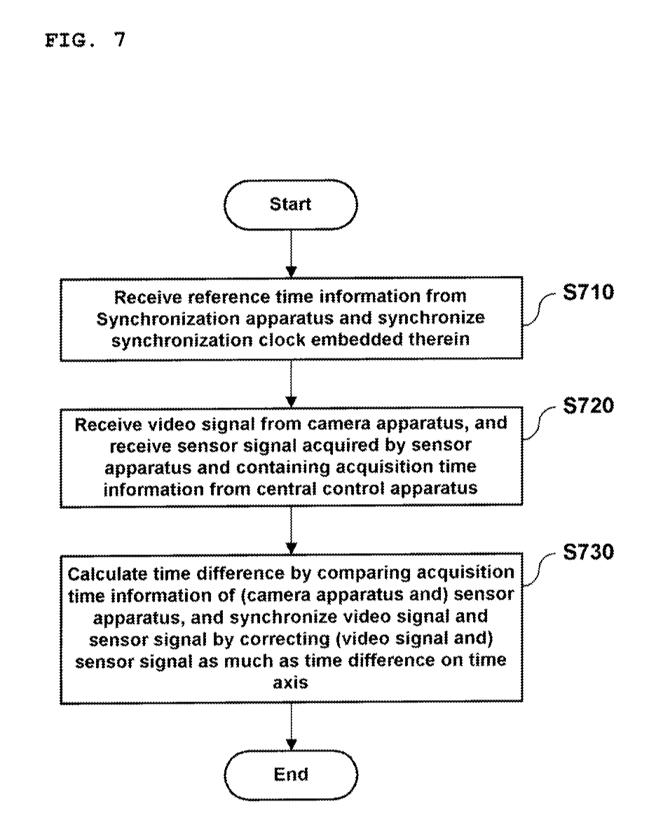

Next, the synchronization apparatus 120 requests and receives current time information as shown in FIG. 6 from a specific apparatus including the sensor apparatuses 130 to 134 and the central control apparatus 140 S604. FIG. 6 is a view showing a synchronization procedure and a timing diagram according to an embodiment of the present invention. In FIG. 6, ΔT1 denotes a time difference between the synchronization apparatus 120 and the sensor apparatuses 130 to 134 before time correction, Δt1 denotes a time information transmission delay time caused by a serial communication, Δt2 denotes a time of transmitting current time information from the sensor apparatuses 130 to 134, Δt3 denotes a time for confirming the time difference and setting a time and a command transfer delay time at the synchronization apparatus 120, and Δt4 denotes a time of waiting for correction after receiving time information from the synchronization apparatus 120.

Next, the synchronization apparatus 120 acquires time difference information by comparing the received current time information with the reference time information S506.

Next, the synchronization apparatus 120 generates correction time information for correcting the time difference information S508.

Next, the synchronization apparatus 120 transmits the generated correction time information and a time correction command to the specific apparatus including the sensor apparatuses 130 to 134 and the central control apparatus 140 S510.

Then, the specific apparatus including the sensor apparatuses 130 to 134 and the central control apparatus 140 corrects and synchronizes the embedded synchronization clock to the correction time information based on the correction time information and the time correction command received from the synchronization apparatus 120, and transmits a synchronization completion command informing completion of the synchronization to the synchronization apparatus 120.

Accordingly, the synchronization apparatus 120 receives the synchronization completion command informing completion of synchronization as a time correction performed based on the correction time information from the apparatus including the sensor apparatuses 130 to 134 and the central control apparatus 140 S512.

FIG. 7 is a flowchart illustrating a method of synchronizing a video signal and a sensor signal of a computer apparatus according to an embodiment of the present invention.

Referring to FIG. 7, the computer apparatus 150 according to the present invention receives reference time information from the synchronization apparatus 120 and synchronizes the synchronization clock embedded therein S710.

Next, the computer apparatus 150 receives a video signal from the camera apparatus 110 and receives a sensor signal acquired by the sensor apparatuses 130 to 134 and added with acquisition time information from the central control apparatus 140 S720.

Next, the computer apparatus 150 synchronizes the video signal and the sensor signal based on the time information of the embedded second synchronization clock and the acquisition time information S730.

In addition, the computer apparatus 150 calculates a time difference by comparing the time information of the second synchronization clock with the acquisition time information of the sensor apparatuses 130 to 134 and synchronizes the video signal and the sensor signal by correcting the sensor signal as much as the time difference on the time axis.

Meanwhile, since the video signal and the sensor signal can be desynchronized while the video signal and the sensor signal are acquired from the camera apparatus 110 and the sensor apparatuses 130 to 134, the computer apparatus 150 should verify the synchronization after the signals are acquired. Accordingly, the central control apparatus 140 calculates a time difference between video signal acquisition time information of the camera apparatus 110 and sensor signal acquisition time information of the sensor apparatuses 130 to 134 and transfers the calculated time difference to the computer apparatus 150, and the computer apparatus 150 corrects corresponding information as much as the transferred time difference on the time axis. Of course, it is possible that the central control apparatus 140 does not calculate the time difference, and the computer apparatus 150 calculates the time difference by itself and corrects the video signal and the sensor signal as much as the time difference.

According to the present invention described above, it is possible to implement a system and method for synchronizing a video signal and a sensor signal, a synchronization apparatus and a method of synchronizing a video signal and a sensor signal thereof, and a computer apparatus and a method of synchronizing a video signal and a sensor signal thereof, in which a synchronization clock is embedded in each sensor module and a central control apparatus to synchronize the video signal inputted from a camera and the sensor signal corresponding to each video signal. The synchronization apparatus transmits a synchronization signal to each apparatus to synchronize the synchronization clocks, and the sensor apparatus adds an acquisition time to the acquired sensor signal and transmits the sensor signal to a computer apparatus via the central control apparatus. Then, the central control apparatus adds an acquisition time to the number of acquisitions of the video signal transmitted from the camera to the computer apparatus and transmits the number of acquisitions to the computer apparatus, and the computer apparatus performs synchronization for the video signal and the sensor signal.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

The present invention can be applied to a system and a service that should provide video signals acquired from a camera apparatus and sensor signals acquired from a sensor apparatus as a screen and a sound simultaneously.

In addition, the present invention can be applied to an apparatus which generates a video signal and a sensor signal and transmits the signals in a wireless or wired communication.

Furthermore, the present invention can be applied to an apparatus, a system or the like which analyze multi-channel video signals and sensor signals.

1. A system for synchronizing a video signal and a sensor signal, the system comprising:
a camera apparatus for acquiring the video signal by photographing a subject, and outputting and transmitting the acquired video signal;
a sensor apparatus embedded with a first synchronization clock, for generating the sensor signal corresponding to the video signal according to a sensing operation, adding acquisition time information of the first synchronization clock to the generated sensor signal, and outputting the sensor signal;
a central control apparatus embedded with a second synchronization clock, for controlling to receive the sensor signal added with the acquisition time information from the sensor apparatus and transmit the sensor signal to a computer apparatus, continuously accumulating the number of acquisitions of the video signal transmitted from the camera apparatus to the computer apparatus, adding acquisition time information of the second synchronization clock to the number of acquisitions, transmitting the number of acquisitions to the computer apparatus or storing the number of acquisitions, and verifying synchronization using the number of acquisitions when performing analysis;
a synchronization apparatus embedded with a reference clock, for simultaneously transmitting a reference time for synchronizing the first synchronization clock and the second synchronization clock to the sensor apparatus and the central control apparatus at regular intervals; and
a computer apparatus for receiving the sensor signal added with the acquisition time information from the central control apparatus, receiving the video signal from the camera apparatus, confirming the acquisition time information of each of the video signal and the sensor signal, reconfiguring each of the signals in a same time zone, and synchronizing the video signal and the sensor signal.

2. The system according to claim 1, wherein the sensor apparatus synchronizes the first synchronization clock based on the reference time received from the synchronization apparatus, adds acquisition time information by the first synchronization clock to the sensor signal generated according to a sensing operation, and transmits the sensor signal to the central control apparatus.

3. The system according to claim 2, wherein the sensor apparatus compares the reference time received from the synchronization apparatus with a time of the second synchronization clock and performs correction as much as a time difference, adds acquisition time information to the sensor signal based on the corrected time, and transmits the sensor signal to the central control apparatus.

4. The system according to claim 1, wherein the sensor apparatus obtains a time difference by comparing the reference time received from the synchronization apparatus with a time of the first synchronization clock and transmits the obtained time difference to the computer apparatus, and the computer apparatus corrects the sensor signal received from the sensor apparatus as much as the time difference on a time axis.

5. The system according to claim 1, wherein the synchronization apparatus requests and acquires current time information from the sensor apparatus, confirms a time difference range by comparing the acquired current time information with the reference time information, and transmits correction time information and a time correction command to the sensor apparatus if correction is needed.

6. The system according to claim 5, wherein if the time correction command is received, the sensor apparatus performs correction based on the received correction time information, performs synchronization using a clock received from the synchronization apparatus at a second clock, and transmits a correction completion command to the synchronization apparatus.

7. (canceled)

8. A synchronization apparatus comprising:
a communication unit for communicating with a sensor apparatus, a central control apparatus and a computer apparatus;
a frequency generation unit (oscillator) for generating a frequency signal in order to transmit reference time information for synchronization to the sensor apparatus, the central control apparatus and the computer apparatus;
a synchronization clock unit for generating a clock signal from the generated frequency signal;
a reference time module unit (FPGA) for generating the reference time information from the generated clock signal;
a real-time clock (RTC) unit for providing the reference time module unit with a real time clock (RTC); and
a control unit for controlling the frequency generation unit, the synchronization clock unit and the reference time module unit to generate the reference time information and control to transmit the generated reference time information to the sensor apparatus, the central control apparatus and the computer apparatus,
wherein the control unit requests and acquires current time information from the sensor apparatus, confirms a time difference range by comparing the acquired current time information with the reference time information, and transmits correction time information and a time correction command to the sensor apparatus if correction is needed.

9. The apparatus according to claim 8, further comprising:
an A/D converter for converting an analog signal inputted from the sensor apparatus, the central control apparatus and the computer apparatus into a digital signal;
an output unit for outputting the digital signal; and
a display unit for displaying an operation of generating the reference time information, the current time information, and an operation of transmitting the time correction command.

10. A sensor apparatus comprising:
a sensor for generating a sensor signal sensing a slope, tension, weight;
a signal conversion unit for converting the sensor signal of an analog form into sensor data of a digital form;
a communication unit for transmitting the sensor data to a synchronization apparatus and a central control apparatus;
a synchronization clock unit for performing synchronization using a reference time provided by the synchronization apparatus;
a memory unit for storing the sensor data;
a control unit for controlling to transmit the sensor data to the central control apparatus, receive the reference time from the synchronization apparatus and synchronize using the reference time, and transmit acquisition time information of the sensor data to the central control apparatus with the sensor data;
a frequency generation unit for generating a frequency signal and providing the control unit with the frequency signal; and
a real-time clock module (RTC) unit for providing the control unit with a real time clock.

11. A method of synchronizing a video signal and a sensor signal of a system including a camera apparatus, a sensor apparatus, a central control apparatus, a synchronization apparatus and a computer apparatus, the method comprising the steps of:
(a) transmitting synchronization time information to the sensor apparatus and the central control apparatus by the synchronization apparatus;
(b) synchronizing an embedded synchronization clock based on the synchronization time information by the sensor apparatus and the central control apparatus, respectively;
(c) acquiring and transmitting the video signal to the computer apparatus by the camera apparatus;
(d) acquiring the sensor signal, adding acquisition time information by the embedded synchronization clock to the sensor signal, and transmitting the sensor signal to the central control apparatus by the sensor apparatus, and transmitting the sensor signal added with the acquisition time information to the computer apparatus by the central control apparatus; and
(e) performing synchronization of the video signal and the sensor signal based on time information of the embedded synchronization clock and the acquisition time information by the computer apparatus.

12. The method according to claim 11, wherein in step (e), the computer apparatus calculates a time difference by comparing the time information of the embedded synchronization clock and the acquisition time information and synchronizes the video signal and the sensor signal by correcting the video signal and the sensor signal as much as the time difference on a time axis.

13. A method of synchronizing a video signal and a sensor signal of a synchronization apparatus communicating with a specific apparatus including a sensor apparatus, a central control apparatus and a computer apparatus in a wired or wireless communication, the method comprising the steps of:
(a) requesting and receiving current time information from the specific apparatus:
(b) acquiring time difference information by comparing the current time information with reference time information;
(c) generating time information for correcting the time difference information, and transmitting the time information and a time correction command to the specific apparatus; and
(d) receiving a synchronization completion command informing completion of synchronization as a time correction performed based on the time information from the specific apparatus.

14. A method of synchronizing a video signal and a sensor signal of a computer apparatus communicating with a camera apparatus, a sensor apparatus, a central control apparatus and a synchronization apparatus in a wired or wireless communication, the method comprising the steps of:
(a) receiving reference time information from the synchronization apparatus and synchronizing an embedded synchronization clock with the reference time information;
(b) receiving the video signal from the camera apparatus, and receiving the sensor signal including acquisition time information acquired by the sensor apparatus from the central control apparatus; and
(c) synchronizing the video signal and the sensor signal based on time information of the embedded synchronization clock and the acquisition time information.

15. The method according to claim 14, wherein step (c) calculates a time difference by comparing the time information of the embedded synchronization clock and the acquisition time information and synchronizes the video signal and the sensor signal by correcting the video signal and the sensor signal as much as the time difference on a time axis.

16. The method according to claim 14, wherein step (c) synchronizes the video signal and the sensor signal by correcting the video signal and the sensor signal as much as time difference information on a time axis based on the time difference information received from the sensor apparatus and the central control apparatus.
